(19) United States
(12) Patent Application Publication
(10) Pub. No.: US 2024/0394528 A1
(43) Pub. Date: Nov. 28, 2024

(54) SYSTEM AND METHODS FOR AUTOMATICALLY AUGMENTING MACHINE LEARNING TRAINING DATASET BY USING DEEP GENERATIVE MODELS

(71) Applicants: Constructor Autonomous AG, Schaffhausen (CH); Constructor Education and Research Genossenschaft, Schaffhausen (CH)

(72) Inventors: Andrei Boiarov, Sofia (BG); Igor Bykovskih, Istanbul (TR); Nikita Koritsky, Istanbul (TR); Ilya Shimchik, Istanbul (TR); Serg Bell, Singapore (SG); Stanislav Protasov, Singapore (SG); Nikolay Dobrovolskiy, Istanbul (TR); Sergey Ulasen, Singapore (SG)

(21) Appl. No.: 18/322,316

(22) Filed: May 23, 2023

(51) Int. Cl. G06N 3/08

(52) U.S. Cl. CPC G06N 3/08

(57) ABSTRACT

Systems and methods for augmenting a training dataset. The method includes gaining access to at least one insufficient training dataset for training a neural network NN. A generative convolutional neural network GCNN is trained using the training set or a subset thereof. At least one additional item is generated by the GCNN trained on the existing training set, and the generated item is added to the original training set.

### TECHNICAL FIELD

The present disclosure generally relates to augmenting a dataset for a machine-learning model. In particular, the present disclosure relates to augmenting datasets via Generative Neural Networks.

### BACKGROUND

Training data is key to any machine learning model. For the effectiveness of the training data set, the amount of data and how clean the data is plays an important role in maintaining accuracy for all machine learning algorithms. Some of the key features of a good training dataset include reliability, feature representation, and minimal skew. The training data sets are especially important for supervised learning models, which are trained on labeled datasets.

Due to the proliferation of data on the internet in recent times, it is necessary to make regular augmentations to the training datasets. In accordance with some typical implementations, large datasets are collected using automatic or automated tools, where large audiences assist in labeling efforts. In some cases, it is crucial to minimize the learning time for the machine learning system. A need may arise to start using the system when not enough items have been collected and labeled for the training dataset. More specifically, some situations may call for using the system when the training dataset has insufficient labeled items therein.

As such, there is a need for systems and methods to automatically generate items similar to the items present in the existing dataset for the purpose of augmenting the existing training dataset to make the training dataset sufficient for use in the machine learning system.

### SUMMARY

In an embodiment, present disclosure describes a method for automatically augmenting a machine learning dataset. The method includes gaining access to at least one insufficient training dataset for training a neural network NN. The method includes using at least one sufficiency criteria, determining that the training dataset is insufficient for training the neural network NN. The method includes selecting a generative convolutional neural network GCNN for which the existing training dataset is sufficient to get trained; Subsequently, a generative convolutional neural network GCNN is trained using the training set or a subset of that training set. At least one additional item is generated by the GCNN trained on the existing training set, and the additional item is added to the original training set.

In an embodiment, the training dataset includes items, item labels, and other meta-information corresponding to each of the items.

In an embodiment, gaining access to at least one insufficient training dataset for training a neural network NN further includes the identifying if the training dataset is sufficient for training the neural network NN based on at least one sufficiency criterion.

In an embodiment, the GCNN has the same degree of freedom as NN. Neural networks use degrees of freedom to define the independent variables in a calculation.

In an embodiment, the number of degrees of freedom of the GCNN is decreased from the degree of freedom of NN to require fewer items in a GCNN training set to make the existing training set sufficient for the GCNN training.

In an embodiment, different parameters including degrees of freedom are omitted in the GCNN to generate consecutive new items.

In an embodiment, the omitted degrees of freedom in the GCNN are determined based on the statistical parameters related to different parameters of items within the original training set.

In an embodiment, adding an additional item to the original training set is followed by checking the augmented training dataset for sufficiency to train the NN.

In an embodiment, after determining that the augmented training dataset is insufficient to train the NN, checking the augmented training dataset for sufficiency to train the NN is followed by another execution of the method.

In an embodiment, after determining that the augmented training dataset is sufficient to train the NN, checking the augmented training dataset for sufficiency to train the NN is followed by training the NN.

In an embodiment, the present disclosure also describes a system for automatically augmenting an insufficient training dataset for a neural network NN. The system includes a data storage configured to store a training dataset. The system also includes a data generator including a generative convolutional neural network GCNN configured to be trained on the same type of datasets as the NN and to output, after training, a new generated item. A dataset augmenter is configured to add the newly generated item to the training dataset.

In an embodiment, the training dataset includes items, item labels, and other meta-information corresponding to each item.

In an embodiment, the system further includes a sufficiency checker configured to determine if the training dataset is sufficient to train the neural network NN based on at least one sufficiency criterion.

In an embodiment, the GCNN within the data generator has the same degree of freedom as NN.

In an embodiment, the number of degrees of freedom of the GCNN within the data generator is decreased from the degree of freedom of the NN to require fewer items in GCNN training set to make the existing training set sufficient for GCNN training.

In an embodiment, different parameters including degrees of freedom are omitted in the GCNN within the data generator to generate consecutive new items.

In an embodiment, the omitted degrees of freedom in the GCNN within the data generator are determined based on the statistical parameters related to different parameters of items within the original training set.

In an embodiment, the sufficiency checker is further configured to initiate generation of a new item using the data generator and the training set or its subset if the existing training dataset is determined to be insufficient to train the NN.

In an embodiment, the system further includes a training module configured to train the NN if the sufficiency checker determines that the training set is sufficient to train the NN.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for automatically augmenting an insufficient training dataset for a neural network NN, in accordance with one implementation of an embodiment.

FIG. 2 is a block diagram of the system shown in FIG. 1, in accordance with one implementation of an embodiment.

FIG. 3 is a flowchart of a method for automatically augmenting a machine learning dataset, in accordance with one implementation of an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Embodiments of present disclosure describes systems and methods for automatically augmenting ML training datasets. More specifically, the systems and methods, in accordance with embodiments of the present disclosure, are configured to automatically generate items similar to the items present in the existing dataset for the purpose of augmenting the existing training dataset to make the training dataset sufficient for use in the machine learning system.

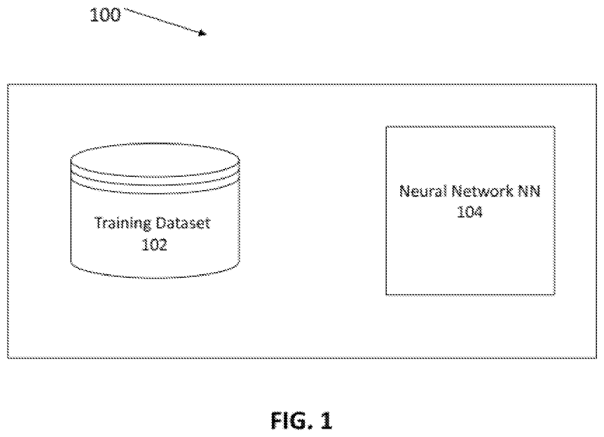

Referring to FIG. 1, a block diagram of a system 100 for augmenting a training dataset 102 that includes a plurality of items is depicted, according to an embodiment. A training dataset 102 can be understood as a set of raw information of the items that a machine learning model 104 can process and interpret to identify a pattern(s) so that a computing device can interpret real-time data based on the identified pattern(s). The training dataset 102 can include items, item labels, and other meta-information corresponding to each item. Further, the machine learning model 104 can be a neural network (NN).

The system 100 is configured to process training dataset 102 using various types of items which makes the system 100 versatile in handling different kinds of training dataset 102. Further, augmenting the training dataset 102 can be understood as adding additional items to the training dataset 102 so that the training dataset 102 has sufficient items so that the NN 104 can be trained accurately.

Further, the items, in some embodiments, are a numeric sequence as in digital processing and communications, each object is ultimately represented by sequences of zeros and ones which can also be interpreted as numbers. Further, the system 100 can augment the numeric sequence-based training dataset 102 by inserting missing numbers from the sequence. In another embodiment, the item is a string of symbols and the system 100 can generate additional similar symbols to augment the string of symbol-based training dataset 102. An example is generation of text that is formally similar to the remaining data set yet is different from the other elements in the set. In yet another embodiment, the item is an image or video fragment and the system 100 can generate images or video fragments similar to the existing image-based or video fragment-based training dataset 102.

The system 100 is configured to augment the training dataset 102 because the training dataset 102 may be insufficient to adequately train the NN 104. In one example, the system 100 can employ a separate machine-learning technique to augment the training dataset 102 for the NN 104. The separate machine learning model, in some embodiments, can be Generative convolutional neural networks Generative CNN or GCNN. Examples of such ML systems are Generative Adversarial Network, Variational Autoencoders, and Diffusion Model.

The system 100 can first train the GCNN using the training dataset 102 to augment the training dataset 102. In some embodiments, the system 100 can train the GCNN using a subset of the training dataset 102 to augment the training dataset 102. Since the system 100 is capable of augmenting the training dataset 102 with a subset, the system 100 enables the accurate augmentation of the training dataset 102 with a lesser number of items.

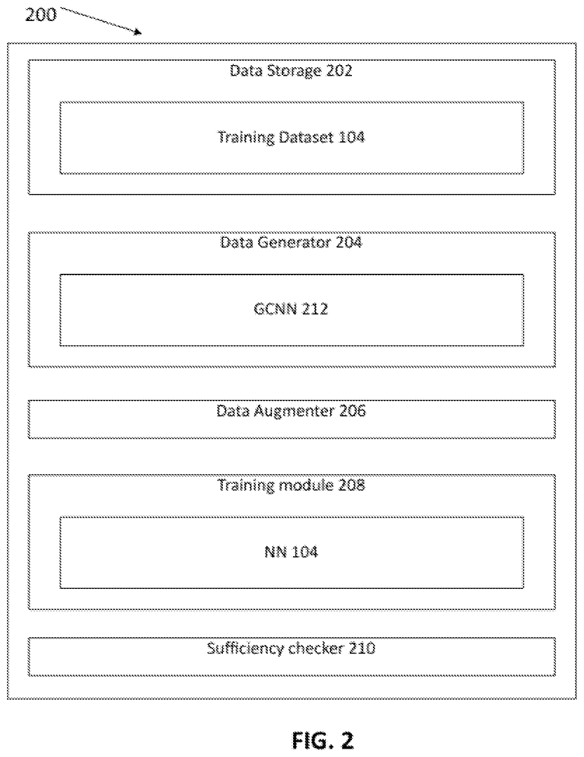

In one embodiment, the training dataset 102 can be stored in a computer-readable medium, such as in a hard drive or on cloud storage. The system 100 can interact with the training dataset 102 over a wired or wireless network. Details of the system 100 are provided with respect to FIG. 2.

Referring to FIG. 2, a block diagram of the system 100 is depicted, in accordance with one embodiment of the present disclosure. The system 100 can include, but is not limited to, a data storage 202, a data generator 204, a dataset augmenter 206, a training module 208, and a sufficiency checker 210. These components of the system 100 can be implemented either as hardware implement within the system 100 or software modules executed by a processor within the system 100.

The system includes various engines (or modules, etc.), each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

The data storage 202 is configured to store training dataset 102. In one example, the training dataset can be either the complete training dataset 102 or a subset of training dataset 102.

In an embodiment, the data generator 204 includes the GCNN 212 and is configured to be trained with the same type of datasets as the NN 104. Further, the data generator 204 is configured to output a newly generated item after the training. The generated item can be appended to the training dataset 102 to form the augmented training dataset 102. Further, the training module 208 can use the augmented training dataset 102 to train the NN 104. The training module 208 can also deploy the trained NN 104 to process real-time items received at a later point in time.

In an embodiment, the sufficiency checker 210 is configured to check if the training dataset 102 is sufficient to train the neural network NN 104. Further, the sufficiency checker 210 can determine if the training dataset 102 is based on one or more sufficiency criteria. In an embodiment, one or more sufficiency criteria can be a combination of multiple criteria. The sufficiency criterion can be based on the heuristic analysis of known systems of similar nature and similar number of degrees of freedom of NN. For example, the heuristic rule may determine that the model requires N*D or D², where D is the number of degrees of freedom of the neural network, and N is a number. The sufficiency criterion can be a threshold value related to the minimum number of items in the training dataset 102. During the operation, the sufficiency checker 210 can compare the number of items in the training dataset 102 with a threshold value determined, for example, heuristically. In case the number of items in the training dataset 102 is greater than the threshold value, the sufficiency checker 210 determines that the training dataset 102 is sufficiently large to train the NN 104. On the other hand, in the case where the number of items in the training dataset 102 is less than the threshold value, the sufficiency checker 210 determines that the training dataset 102 is insufficient in training the NN 104 and should be augmented. Accordingly, the sufficiency checker is further configured to initiate the generation of a new item using the data generator 204 and the training dataset 102.

As mentioned, the data generator 204 is configured to generate new items to augment the training dataset 102. The data generator 204 is also configured to train the GCNN 212 to generate the new items. In one embodiment, to train the GCNN 212, the degrees of freedom of the GCNN 212 should be the same as the degrees of freedom of the NN 104. Neural networks use degrees of freedom to define the independent variables in a calculation. Accordingly, the complete training dataset 102 is used to train the GCNN 212.

In some embodiments, the degree of the GCNN 212 can be different from the degrees of freedom of the NN 104. In such a case, the data generator 204 can determine a difference between the degrees of freedom of both the GCNN 212 and the NN 104. Accordingly, the data generator 204 can decrease the degree of freedom of the GCNN 212 from the degree of freedom of NN 104. The decrease in the degree of freedom of the GCNN 212 results in the requirement of fewer items in a GCNN training set. The requirement of fewer degrees of freedom makes the existing training set sufficient for the training of GCNN 212.

In one example, the data generator 204 can determine the degrees of freedom that are not needed. Such degrees of parameters are called different parameters. The different parameters are omitted so that the GCNN 212 generates consecutive new items. Such a provision enables simple appending of the new items in the original training dataset 102. Further, the different parameters are omitted based on the statistical parameters related to different parameters of items within the original training dataset 102.

Once the new items are added to the original training dataset 102, the sufficiency checker 210 again checks if the augmented training dataset 102 is sufficient to train the NN 104. In one example, the sufficiency checker 210 can check if the augmented training dataset 102 is sufficient based on the sufficiency criterion. In case the sufficiency checker 210 determines that the augmented training dataset 102 is sufficient, the sufficiency checker 210 can execute the training module 208. Further, the training module 208 can train the NN 104 based on the execution by the sufficiency checker 210.

In case the sufficiency checker 210 determines if the augmented training dataset 102 is insufficient, the sufficiency checker 210 can actuate the data generator 204 and the dataset augmenter 206 for another execution.

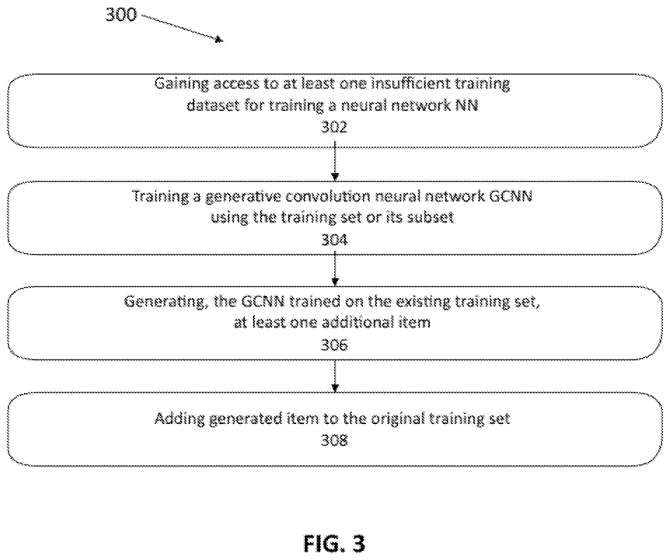

Referring to FIG. 3, a flowchart of a method 300 for automatically augmenting a training dataset 102 is depicted, according to an embodiment. The method 300 can be implemented by a computer device having a processor and a memory coupled to the processor. The method is implemented for augmenting the training dataset 102 using a GCNN 212.

At block 302, the method includes gaining access to at least one insufficient training dataset 102 for training the NN 104.

At block 304, the method includes training the GCNN 212 using the training dataset 102 or its subset.

At block 306, the method includes generating, the GCNN 212 trained on the existing training set, at least one additional item.

At block 308, the method includes adding generated items to the original training dataset 102.

In some embodiments, the method includes adding the generated item to the original training dataset 102 followed by checking the augmented training dataset for sufficiency to train the NN 104.

In some embodiments, the method further includes determining that the augmented training dataset is insufficient to train the NN 104. Accordingly, checking the augmented training dataset 102 for sufficiency to train the NN 104 is followed by another execution of the method of blocks 302 to 308.

In some embodiments, the method further includes after determining that the augmented training dataset is sufficient to train the NN 104. Accordingly, checking the augmented training dataset for sufficiency to train the NN 104 is followed by training the NN 104.

1. A method for automatically augmenting a machine training dataset, the method comprising:
gaining access to a training dataset for training a neural network NN;
using at least one sufficiency criteria, determining that the training dataset is insufficient for training the neural network NN;
selecting a generative convolutional neural network GCNN for which the existing training dataset is sufficient to get trained;
training the generative convolutional neural network GCNN using the training dataset or a subset of the training dataset;
generating, by the GCNN trained on the existing training dataset, an additional item; and
adding the additional item to the training dataset.

2. The method of claim 1, wherein the training dataset comprises items, item labels, and other meta-information corresponding to each of the items.

3. The method of claim 1, wherein the gaining access to the insufficient training dataset for training a neural network NN further comprises identifying if the training dataset is sufficient for training the neural network NN based on a sufficiency criterion.

4. The method of claim 1, wherein the GCNN has the same degree of freedom as NN.

5. The method of claim 1, wherein the degrees of freedom of the GCNN is decreased from the degree of freedom of NN to require fewer items in a GCNN training set to make the existing training set sufficient for the GCNN training.

6. The method of claim 5, wherein different parameters comprising degrees of freedom are omitted in the GCNN to generate consecutive new items.

7. The method of claim 6, wherein the omitted degrees of freedom in the GCNN are determined based on statistical parameters related to different parameters of items within the training set.

8. The method of claim 1, further comprising checking the augmented training dataset for sufficiency to train the NN after adding the at least one additional item to the original training set.

9. The method of claim 8, further comprising, when checking the augmented training dataset for sufficiency to train the NN, and determining that the augmented training dataset is insufficient to train the NN, executing the method of claim 1.

10. The method of claim 8, further comprising, when checking the augmented training dataset for sufficiency to train the NN, and determining that the augmented training dataset is sufficient to train the NN, training the NN.

11. A system for automatically augmenting an insufficient training dataset for a neural network NN, the system comprising:
a data storage configured to store a training dataset;
a data generator comprising a generative convolutional neural network GCNN configured to be trained on a same type of datasets as the NN and to output, after training, a new generated item; and
a dataset augmenter configured to add the new generated item to the training dataset.

12. The system of claim 11, wherein the training dataset comprises items, item labels, and other meta-information corresponding to each item.

13. The system of claim 11, wherein the system further comprises a sufficiency checker configured to determine if the training dataset is sufficient to train the neural network NN based on at least one sufficiency criterion.

14. The system of claim 11, wherein the GCNN within the data generator has the same degree of freedom as NN.

15. The system of claim 11, wherein the degrees of freedom of the GCNN within the data generator is decreased from the degree of freedom of the NN to require fewer items in a GCNN training set to make the existing training set sufficient for GCNN training.

16. The system of claim 15, wherein different parameters comprising degrees of freedom are omitted in the GCNN within the data generator to generate consecutive new items.

17. The system of claim 15, wherein the omitted degrees of freedom in the GCNN within the data generator are determined based on statistical parameters related to different parameters of items within the original training set.

18. The system of claim 13, wherein the sufficiency checker is further configured to initiate generation of a new item using the data generator and the training set or its subset if the existing training dataset is determined to be insufficient to train the NN.

19. The system of claim 13, further comprising a training module configured to train the NN if the sufficiency checker determines that the training set is sufficient to train the NN.
